(19) United States
(12) Patent Application Publication
(10) Pub. No.: US 2026/0065457 A1
(43) Pub. Date: Mar. 5, 2026

(54) SELF-OPERATING SUBSTRATE MEASUREMENT

(71) Applicant: Applied Materials, Inc., Santa Clara, CA (US)

(72) Inventors: Abhinav Kumar, San Jose, CA (US); Ioannis Papakis, San Jose, CA (US); Anjan Kumar Patra, Bengaluru (IN); Sunil K.V., Bangalore (IN); Adrienne Melissa Martin Bergh, Los Gatos, CA (US)

(21) Appl. No.: 19/314,236

(22) Filed: Aug. 29, 2025

(30) Foreign Application Priority Data
Aug. 30, 2024 (WO) PCT/GR2024/000023

(51) Int. Cl. G06T 7/00

(52) U.S. Cl. CPC G06T 7/0004; G06T 2207/20081; G06T 2207/30148

(57) ABSTRACT

A method includes obtaining, by a processing device, a first image of a first substrate including a first set of substrate structures. The method further includes obtaining a first set of measurements in association with the first set of substrate structures. The method further includes obtaining a second image of a second substrate including a second set of substrate structures corresponding to the first set of substrate structures. The method further includes determining a set of unit structures of the second image. Each of the unit structures is associated with one of the second set of substrate structures. Determining the set of unit structures is performed based on the first set of measurements. The method further includes determining a second set of measurements. The second set of measurements correspond to the first set of measurements. The second set of measurements are in association with the set of unit structures.

### RELATED APPLICATIONS

This application claims the benefit of International Application No.: PCT/GR2024/000023, filed Aug. 30, 2024, entitled “SELF-OPERATING SUBSTRATE MEASUREMENT,” which is incorporated herein by reference.

### TECHNICAL FIELD

The present disclosure relates to methods associated with measurements of substrates. In particular, the present disclosure relates to methods associated with self-operating substrate measurement.

### BACKGROUND

Products may be produced by performing one or more manufacturing processes using manufacturing equipment. For example, semiconductor manufacturing equipment may be used to produce substrates via semiconductor manufacturing processes. Products are to be produced with particular properties, suited for a target application. Determining whether a product meets production criteria may include measuring one or more features of the substrate.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

In one aspect of the present disclosure, a method includes obtaining, by a processing device, a first image of a first substrate including a first set of substrate structures. The method further includes obtaining a first set of measurements in association with the first set of substrate structures. The method further includes obtaining a second image of a second substrate including a second set of substrate structures corresponding to the first set of substrate structures. The method further includes determining a set of unit structures of the second image. Each of the unit structures is associated with one of the second set of substrate structures. Determining the set of unit structures is performed based on the first set of measurements. The method further includes determining a second set of measurements. The second set of measurements correspond to the first set of measurements. The second set of measurements are in association with the set of unit structures. The method further includes providing an alert to a user indicative of the second set of measurements.

In another aspect of the present disclosure, a method includes obtaining, by a processing device, a first image of a first substrate including a first set of substrate structures. The method further includes obtaining a first set of measurements in association with the first set of substrate structures. The method further includes obtaining a first set of material labels corresponding to each of the first set of substrate structures. The method further includes determining a second set of material labels corresponding to each of a second set of substrate structures of a second image of a second substrate. The method further includes matching the first set of material labels to the second set of material labels based on centroids of materials of the first and second set of substrate structures to determine correspondence between the first set of material labels and the second set of material labels. The method further includes determining a second set of measurements of the second set of substrate structures based on the correspondence between the first set of material labels and the second set of material labels, and the first set of measurements.

In another aspect of the present disclosure, a non-transitory machine-readable storage medium stores instructions which, when executed, cause a processing device to perform operations including obtaining a first image of a first substrate including a first set of substrate structures. The operations further include obtaining a first set of measurements in association with the first set of substrate structures. The operations further include obtaining a second image of a second substrate including a second set of substrate structures corresponding to the first set of substrate structures. The operations further include determining a set of unit structures of the second image. Each of the unit structures is associated with one of the second set of substrate structures. Determining the set of unit structures is performed based on the first set of measurements. The operations further include determining a second set of measurements. The second set of measurements correspond to the first set of measurements. The second set of measurements are in association with the set of unit structures. The operations further include providing an alert to a user indicative of the second set of measurements.

### BRIEF DESCRIPTION OF THE DRAWINGS

The present disclosure is illustrated by way of example, and not by way of limitation in the figures of the accompanying drawings.

FIG. 1 is a block diagram illustrating an exemplary system, according to some embodiments.

FIG. 2 is a block diagram depicting a flow for generation and use of a self-operating measurement recipe, according to some embodiments.

FIG. 3A is a block diagram of a substrate image including example measurements, according to some embodiments.

FIG. 3B depicts block diagrams of material labeling of an example structure and target structure, according to some embodiments.

FIG. 4A depicts a substrate structure image with a measurement arc to be adjusting in accordance with optimal matching techniques, according to some embodiments.

FIG. 4B includes example traces that may be used for optimal matching, according to some embodiments.

FIG. 5A is a block diagram of a method for generating a data set, according to some embodiments.

FIG. 5B is a flow diagram of a method for generating and initiating a self-operating measurement recipe, according to some embodiments.

FIG. 5C is a flow diagram of a method for generating and utilizing a self-operating measurement recipe including identification of materials of substrate structure images, according to some embodiments.

FIG. 6 is a block diagram illustrating a computer system, according to some embodiments.

### DETAILED DESCRIPTION

Described herein are technologies related to generating structure measurements based on images of manufactured products. Manufacturing equipment is used to produce products, such as substrates (e.g., wafers, semiconductors). Manufacturing equipment may include a manufacturing or processing chamber to separate the substrate from the environment. The properties of produced substrates are to meet target values to facilitate specific functionalities. Manufacturing parameters are selected to produce substrates that meet the target property values. Many manufacturing parameters (e.g., hardware parameters, process parameters, etc.) contribute to the properties of processed substrates. Metrology is often performed to measure one or more metrics of interest of processed substrates. In some cases, imaging is performed (e.g., scanning electron microscopy (SEM) or transmission electron microscopy (TEM) imaging) of processed substrates, and one or more measurements of structures of interest may be determined based on the images.

In some systems, measurements may be extracted from images algorithmically. A method may be developed for a processing device, computing device, measurement system, or the like to automatically extract one or more metrics of interest from an image of a substrate, e.g., structure dimensions, critical dimension, structure thickness, structure spacing, sidewall angle, structure uniformity, or any other metric of interest in association with measurements of substrate structures. However, development of algorithmic solutions to image measurements is a costly procedure in terms of time, subject matter expertise, etc. Every type of substrate, substrate structure, substrate measurement, metric of interest, imaging technique, imaging tools that may vary in terms of contrast, sharpness, or the like, and any of a variety of other influencing factors may cause a algorithmic measurement solution to behave erratically, unreliably, inconsistently, or to not perform at all. Such cases may require additional testing to ensure algorithm robustness, additional algorithm modification, development of a new measurement algorithm, or the like, further increasing the cost of algorithmic measurement solutions. Further, algorithmic solutions may be vulnerable to unexpected inconsistencies between substrate images. For example, an algorithmic solution may specify a location at which a measurement is to be taken. However, due to differences in substrate structure or substrate imaging, the specified measurement location may be a poor choice (e.g., a layer of a film may be unexpectedly thin at a region selected by the algorithm for measurement of film thickness). Such unexpected variations may be easily dealt with by a manual measurement system (e.g., by selecting a different area of the film to measure), but may cause an algorithmic solution to fail unless the complexity, and corresponding development cost, is increased.

In some systems, measurements may be extracted from images manually. For example, a user may view a substrate image, place one or more measurement points on the image, and the system may determine a measurement based on the measurement points manually placed by the user. Manual measurements may be costly in terms of time to produce each measurement of interest, time to train users to perform the measurements, delays in producing measurements inherent in manual labeling, etc.

Aspects of the present disclosure may address one or more of the shortcomings of previous methods. In some embodiments, a process recipe may be performed to generate one or more processed substrates. The processed substrates may be of the same design, similar design, different design including nominally identical structures, include similar structures, or the like. Images of the one or more substrates may be taken, e.g., SEM or TEM images that show structures of interest, dimensions of interest, or the like.

The images may be provided to a system for generating a measurement recipe, e.g., a user device. A user may provide one or more measurement endpoints, measurement arcs (e.g., a connection between endpoints, which may be straight or curved), indications of separate portions or materials of structures, bounding boxes indicating borders or separations between structures, etc. In some embodiments, an image may include multiple representations of a type of measurement, e.g., thickness of a structure may be measured, with multiple structures imaged that may be measured manually for use in automatic measurement recipe creation. In some embodiments, multiple measurement types may be represented in an image, e.g., multiple types of structures may be represented, multiple dimensions of interest may be measured on a structure, etc. For example, multiple dimensions of a structure may be measured, such as structure height, structure thickness, film thickness, critical dimension, sidewall angle, structure spacing, etc. In some embodiments, a measurement may be named (e.g., thickness, wall angle, etc.) and the name labels of the measurements may be utilized by the system in determining a correspondence between user-labeled images and images to be measured in accordance with the measurement recipe. A few images (e.g., 3 to 10) may be utilized by a user to perform measurements for recipe creation. Each image may include a number of structures, e.g., 2 to 20 structures may be included in each image. The user-performed manual measurements may be used to generate a measurement recipe, for performing the measurement on additional images by the processing system, rather than manual entry.

The measurement recipe may include performing various operations to match structures of an example image (e.g., an image labeled by a user) to a target image (e.g., a substrate structure image to be processed according to a measurement recipe). A set of unit structures may be identified based on measurements of the one or more example images. A unit structure may be a repeating unit, e.g., including a single structure of an array of structures. Identifying a unit structure may be based on repeated measurements, e.g., repeated patterns in the image with a spatial frequency corresponding to a spatial frequency of a first type of measurement may be utilized in predicting representative unit structures of the image. In some embodiments, manual measurements input by a user may include bounding boxes of unit structures, which may be utilized in predicting bounding boxes for a new substrate image. In some embodiments, correlation methods (e.g., normalized cross correlation) may be utilized in matching unit structures and/or substrate structures between one or more example images and a target image. In some embodiments, a boundary may be determined corresponding to each structure of interest of the target image, based on the measurements placed manually on the one or more example images.

In some embodiments, distortion between the example images and the target image may be accounted for to improve measurement accuracy. A deformation field may be generated based on similarities between one or more example images and the target image to be measured. For example, a deformation field may be generated for a number of example measurement structures in reference to a target measurement structure of the target image. Each deformation field may improve accuracy of measurement placement in the target image, e.g., accurate placement of measurement endpoints. In some embodiments, a rigid registration method of computing the deformation field may be used. In some embodiments, a non-rigid registration method of computing the deformation field may be used. Measurement points (e.g., measurement endpoints, sufficient points to extrapolate a measurement arc, etc.) may be transferred based on the deformation field from the structure measurements of the example images to the target structure to be measured of the target image. In some embodiments, an average placement of one or more measurement points, based on a number of example measurements, may be utilized. In some embodiments, a different statistical metric or other metric may be used to determine which example image structure or structures should be used to determine measurement placement of the target structure for measurement. For example, one or more qualities of the deformation field (e.g., a maximum allowable distortion in the vicinity of the measurement) may be utilized in determining measurement points on the target structure.

In some embodiments, improvements or corrections may be applied to measurement placement. In some embodiments, further corrections may be applied after corrections based on a deformation field. Based on characteristics of the image, such as pixel brightness, corrections may be applied to improve a likelihood of a measurement on the target image falling on the correct portion of the structure image, as determined based on the manual measurement of the example images. A method for determining an optimal matching between one or more example structure measurements and measurements of the target structure may be employed. For example, the measurement may follow a measurement arc (e.g., between two measurement endpoints). One or more image qualities (e.g. pixel brightness) may be used along at least a portion of the measurement arc to generate a measurement arc trace. The measurement arc trace of the one or more example measurements may be compared to one or more provisional measurement arcs to find an optimal matching between the measurement arc traces. An optimal matching algorithm or method may be utilized, such as dynamic time warping. A measurement arc may be extended beyond the measurement or provisional measurement for purposes of generating a measurement arc trace, which may improve performance of an optimal matching or dynamic time warping method. In some embodiments, a window for matching may be specified. In the direction of the measurement arc, a measurement arc trace may be generated, by averaging image quality values (e.g., pixel brightness) in an orthogonal or otherwise different coordinate. For example, a measurement may be a horizontal line on an image. A window near each endpoint of the horizontal measurement line may be defined for optimal matching operations. Pixels stacked vertically may have brightness values averaged to generate the measurement arc trace, then dynamic time warping applied to place measurement endpoints along the provisional measurement arc in an optimal placement for matching the example measurement arcs. For measurement arcs at different angles or including curves, details may be adjusted to generate a value-averaged measurement arc trace in a window for selection of a measurement endpoint along the measurement arc.

In some embodiments, after an automatic measurement recipe is created, it may be stored and accessed at a later time for generating further measurements. In some embodiments, user feedback may be incorporated based on automatic measurements. For example, a user may adjust example measurements or introduce new (e.g., replacement and/or additional) example measurements to adjust or improve performance of the automatic measurement recipe.

Methods and systems of the present disclosure provide technological advantages over conventional solutions. In comparison to algorithmic methods, a self-operating metrology recipe, as described herein, may include less development costs, time, expertise, etc. Further, more flexibility in measurement is achieved, as a fairly small number of manual measurements may be made to generate a new measurement recipe. Small updates to structure shape, substrate design, imaging operation procedures, measurement procedures, measurement location, or the like may cause development of a new algorithm for algorithmic measurement solutions, further incurring costs for development of algorithmic solutions. With a small amount of input from a user, a self-operating measurement recipe may be capable of adapting to any of these scenarios quickly, with labeling of a number of structures from a small number of images, and generation of a measurement recipe based on the measurements.

In comparison to manual methods, a self-operating measurement recipe may provide advantages in terms of user time involved in performing all measurements manually. In many cases, similar measurements may be taken many times on many substrate images, and manual measurement quickly can become cost prohibitive, inconvenient, or impossible. A self-operating measurement recipe, as described herein, may enable agile construction of a measurement recipe, without constant resource-intensive manual labeling or measurement of all future substrates of interest.

In one aspect of the present disclosure, a method includes obtaining, by a processing device, a first image of a first substrate including a first set of substrate structures. The method further includes obtaining a first set of measurements in association with the first set of substrate structures. The method further includes obtaining a second image of a second substrate including a second set of substrate structures corresponding to the first set of substrate structures. The method further includes determining a set of unit structures of the second image. Each of the unit structures is associated with one of the second set of substrate structures. Determining the set of unit structures is performed based on the first set of measurements. The method further includes determining a second set of measurements. The second set of measurements correspond to the first set of measurements. The second set of measurements are in association with the set of unit structures. The method further includes providing an alert to a user indicative of the second set of measurements.

In another aspect of the present disclosure, a method includes obtaining, by a processing device, a first image of a first substrate including a first set of substrate structures. The method further includes obtaining a first set of measurements in association with the first set of substrate structures. The method further includes obtaining a first set of material labels corresponding to each of the first set of substrate structures. The method further includes determining a second set of material labels corresponding to each of a second set of substrate structures of a second image of a second substrate. The method further includes matching the first set of material labels to the second set of material labels based on centroids of materials of the first and second set of substrate structures to determine correspondence between the first set of material labels and the second set of material labels. The method further includes determining a second set of measurements of the second set of substrate structures based on the correspondence between the first set of material labels and the second set of material labels, and the first set of measurements.

In another aspect of the present disclosure, a non-transitory machine-readable storage medium stores instructions which, when executed, cause a processing device to perform operations including obtaining a first image of a first substrate including a first set of substrate structures. The operations further include obtaining a first set of measurements in association with the first set of substrate structures. The operations further include obtaining a second image of a second substrate including a second set of substrate structures corresponding to the first set of substrate structures. The operations further include determining a set of unit structures of the second image. Each of the unit structures is associated with one of the second set of substrate structures. Determining the set of unit structures is performed based on the first set of measurements. The operations further include determining a second set of measurements. The second set of measurements correspond to the first set of measurements. The second set of measurements are in association with the set of unit structures. The operations further include providing an alert to a user indicative of the second set of measurements.

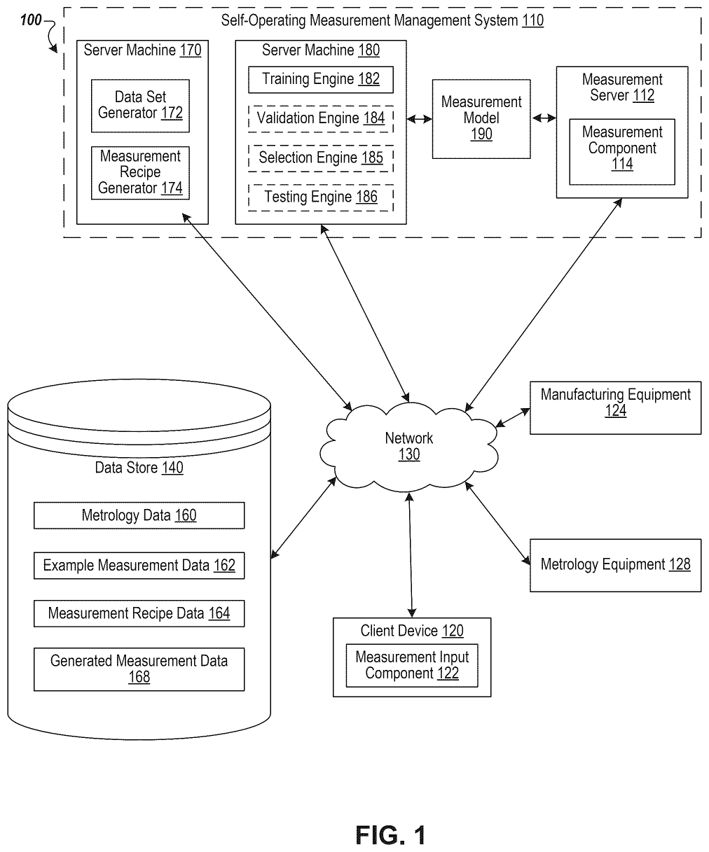

FIG. 1 is a block diagram illustrating an exemplary system 100 (exemplary system architecture), according to some embodiments. The system 100 includes a client device 120, manufacturing equipment 124, metrology equipment 128, measurement server 112, and data store 140. The measurement server 112 may be part of self-operating measurement management system 110. Self-operating measurement management system 110 may further include server machines 170 and 180.

Data store 140 may store various types and categories of data in association with a self-operating measurement system. Data store 140 may store metrology data 160, example measurement data 162, measurement recipe data 164, and generated measurement data 168. In some embodiments, metrology data 160 may be provided by a standalone metrology facility including metrology equipment 128. In some embodiments, metrology data 160 may be provided without use of a standalone metrology facility, e.g., in-situ metrology data (e.g., metrology or a proxy for metrology collected during processing), integrated metrology data (e.g., metrology or a proxy for metrology collected while a product is within a chamber or under vacuum, but not during processing operations), inline metrology data (e.g., data collected after a substrate is removed from vacuum), etc. In some embodiments, metrology data 160 may include synthetic metrology data, e.g., metrology data inferred based on one or more inputs. Metrology data 160 may include substrate images, e.g., scanning electron microscopy (SEM) images, transmission electron microscopy (TEM) images, or the like.

Each instance (e.g., set) of metrology data 160 may correspond to a product (e.g., a substrate), a set of manufacturing equipment, a type of substrate produced by manufacturing equipment, or the like. The data store may further store information associating sets of different data types, e.g. information indicative that a several sets of metrology data 160 are all associated with the same product, manufacturing equipment, type of substrate, type of measurement, etc.

In some embodiments, self-operating measurement management system 110 may provide target images to measurement model 190 for performing measurements. Measurement model 190 may include multiple operations for generating measurements in association with the substrate image. Measurement model 190 may be selected from a library of models, e.g., may be or include a measurement recipe (e.g., stored in data store 140 as measurement recipe data 164). Measurement model 190 may include operations based on manual measurement of similar substrate images performed by a user (e.g., via client device 120, measurement input component 122, etc.). Measurement model 190 may execute an automatic recipe based on a few example measurement inputs as a self-operating measurement system. Measurement model 190 may include execution of a number of different operations, e.g., identification of substrate structures and/or representative units, correlation of example structures to target structures, correction of distortions relative to example structures, placement of measurement endpoints based on image attributes, etc.

In some embodiments, self-operating measurement management system 110 may generate generated measurement data 168 using supervised machine learning (e.g., generated measurement data 168 includes output from a machine learning model that was trained using labeled data, such as metrology image data labeled with measurements. In some embodiments, self-operating measurement management system 110 may generate generated measurement data 168 using unsupervised machine learning (e.g., generated measurement data 168 includes output from a machine learning model that was trained using unlabeled data, output may include clustering results, principle component analysis, anomaly detection, etc.). In some embodiments, self-operating measurement management system 110 may generate generated measurement data 168 using semi-supervised learning (e.g., training data may include a mix of labeled and unlabeled data, etc.). One or more operations of measurement model 190 may be replaced or augmented by a trained machine learning model, e.g., substrate identification, unit structure identification, material differentiation, edge/boundary detection, or other methods that may be performed by trained machine learning models, computer vision, and the like.

Client device 120, manufacturing equipment 124, metrology equipment 128, measurement server 112, data store 140, server machine 170, and server machine 180 may be coupled to each other via network 130 for generating generated measurement data 168, e.g., to perform corrective actions. In some embodiments, network 130 may provide access to cloud-based services. Operations performed by client device 120, self-operating measurement management system 110, data store 140, etc., may be performed by virtual cloud-based devices. In some embodiments, one or more operations described as being performed by self-operating measurement management system 110 may instead or additionally be performed by client device 120, e.g., measurement recipe generation, measurement recipe execution, execution of operations of measurement model 190, etc.

In some embodiments, network 130 is a public network that provides client device 120 with access to the measurement server 112, data store 140, and other publicly available computing devices. In some embodiments, network 130 is a private network that provides client device 120 access to manufacturing equipment 124, metrology equipment 128, data store 140, and other privately available computing devices. Network 130 may include one or more Wide Area Networks (WANs), Local Area Networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

Client device 120 may include computing devices such as Personal Computers (PCs), laptops, mobile phones, smart phones, tablet computers, netbook computers, network connected televisions (“smart TV”), network-connected media players (e.g., Blu-ray player), a set-top-box, Over-the-Top (OTT) streaming devices, operator boxes, etc. Client device 120 may include a measurement input component 122. Measurement input component 122 may receive user input (e.g., via a Graphical User Interface (GUI) displayed via the client device 120) of an indication associated with manufacturing equipment 124. Input may include example measurements in association with an example substrate image for generation of a measurement recipe, selection of a measurement recipe, adjustments to previous measurements as feedback to improve performance of a measurement recipe, etc. In some embodiments, client device 120 transmits the indication to self-operating measurement management system 110, receives output (e.g., generated measurement data 168) from self-operating measurement management system 110, determines a corrective action based on the output, and causes the corrective action to be implemented. In some embodiments, client device 120 obtains generated measurement data 168 and provides an alert to a user indicative of the measurements.

In some embodiments, client device 120 receives an indication of a corrective action from self-operating measurement management system 110 and causes the corrective action to be implemented. Each client device 120 may include an operating system that allows users to one or more of generate, view, or edit data (e.g., indication associated with manufacturing equipment 124, corrective actions associated with manufacturing equipment 124, etc.). Corrective actions to be implemented may include alerting a user, recommending or scheduling preventative maintenance, recommending or scheduling corrective maintenance (e.g., replacement of one or more components of manufacturing equipment 124), updating a process recipe, updating a measurement recipe, initiating a chamber cleaning or seasoning operation, flagging a substrate for additional investigation including additional metrology, or the like.

Performing manufacturing processes that result in defective products can be costly in time, energy, products, components, manufacturing equipment 124, the cost of identifying the defects and discarding the defective product, etc. By performing measurements of substrates according to a self-operating measurement, products which are not predicted to meet performance thresholds may be identified and production halted, corrective actions performed, alerts sent to users, recipes updated, etc.

Performing manufacturing processes that result in failure of the components of the manufacturing equipment 124 can be costly in downtime, damage to products, damage to equipment, express ordering replacement components, etc. By performing measurements of substrates according to a self-operating measurement, system 100 can have the technical advantage of avoiding the cost of one or more of unexpected component failure, unscheduled downtime, productivity loss, unexpected equipment failure, product scrap, or the like, by monitoring the performance over time of components, as expressed in substrate metrology. Performing metrology according to a self-operating measurement system may provide indications of degrading components, drifting chamber condition, degrading imaging or metrology tools, or the like.

Manufacturing parameters may be suboptimal for producing product which may have costly results of increased resource (e.g., energy, coolant, gases, etc.) consumption, increased amount of time to produce the products, increased component failure, increased amounts of defective products, increased environmental impact, etc. By performing measurements of substrates according to a self-operating measurement, system 100 can have the technical advantage of identifying and correcting non-optimal manufacturing parameters (e.g., hardware parameters, process parameters, optimal design) to avoid costly results of suboptimal manufacturing parameters.

Measurement server 112, server machine 170, and server machine 180 may each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc. Operations of measurement server 112, server machine 170, server machine 180, data store 140, etc., may be performed by a cloud computing service, cloud data storage service, etc.

Measurement server 112 may include a measurement component 114. In some embodiments, the measurement component 114 may receive metrology data 160 including images of substrates to be measured, and generate output (e.g., generated measurement data 168) associated with the manufacturing equipment 124 based on one or more measurement recipes. In some embodiments, generated measurement data 168 may include one or more predicted dimension measurements of a processed product. In some embodiments, predictive component 114 may use one or more trained machine learning models 190 to determine the output for performing the corrective action based on current data.

One type of machine learning model that may be used to perform some or all of the tasks associated with self-operating measurement is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g. classification outputs).

A recurrent neural network (RNN) is another type of machine learning model. A recurrent neural network model is designed to interpret a series of inputs where inputs are intrinsically related to one another, e.g., time trace data, sequential data, etc. Output of a perceptron of an RNN is fed back into the perceptron as input, to generate the next output.

Deep learning is a class of machine learning algorithms that use a cascade of multiple layers of nonlinear processing units for feature extraction and transformation. Each successive layer uses the output from the previous layer as input. Deep neural networks may learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. In an image recognition application, for example, the raw input may be a matrix of pixels; the first representational layer may abstract the pixels and encode edges; the second layer may compose and encode arrangements of edges; the third layer may encode higher level shapes (e.g., teeth, lips, gums, etc.); and the fourth layer may recognize a scanning role. Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs may be that of the network and may be the number of hidden layers plus one. For recurrent neural networks, in which a signal may propagate through a layer more than once, the CAP depth is potentially unlimited.

In some embodiments, the various models discussed in connection with model 190 (e.g., supervised machine learning model, unsupervised machine learning model, etc.) may be combined in one model (e.g., an ensemble model), or may be separate models.

Data may be passed back and forth between several distinct models included in model 190, and measurement component 114. In some embodiments, some or all of these operations may instead be performed by a different device, e.g., client device 120, server machine 170, server machine 180, etc. It will be understood by one of ordinary skill in the art that variations in data flow, which components perform which processes, which models are provided with which data, and the like are within the scope of this disclosure.

Data store 140 may be a memory (e.g., random access memory), a drive (e.g., a hard drive, a flash drive), a database system, a cloud-accessible memory system, or another type of component or device capable of storing data. Data store 140 may include multiple storage components (e.g., multiple drives or multiple databases) that may span multiple computing devices (e.g., multiple server computers).

In some embodiments, predictive system 110 further includes server machine 170 and server machine 180. Server machine 170 includes a data set generator 172 that is capable of generating data sets (e.g., a set of data inputs and a set of target outputs) to train, validate, and/or test model(s) 190, including one or more machine learning models. In some embodiments, data set generator 172 may partition historical data (e.g., historical metrology data, historical measurement data, historical measurement labels, etc.) into a training set (e.g., sixty percent of the historical data), a validating set (e.g., twenty percent of the historical data), and a testing set (e.g., twenty percent of the historical data).

Server machine 170 may further include measurement recipe generator 174. Measurement recipe generator 174 may assemble a set of operations for performing measurement of one or more substrate structures based on example measurements provided by a user, e.g., via client device 120. Measurement recipe generator 174 may cause a recipe to be generated in accordance with user selection for performing one or more measurements of substrate structures in a self-operating manner, as described herein.

In some embodiments, self-operating measurement management system 110 (e.g., via measurement component 114) generates multiple sets of features. For example a first set of features may correspond to a first set of types of sensor data (e.g., from a first set of sensors, first combination of values from first set of sensors, first patterns in the values from the first set of sensors) that correspond to each of the data sets (e.g., training set, validation set, and testing set) and a second set of features may correspond to a second set of types of sensor data (e.g., from a second set of sensors different from the first set of sensors, second combination of values different from the first combination, second patterns different from the first patterns) that correspond to each of the data sets.

In some embodiments, machine learning model 190 is provided historical data as training data. The historical data may be or include microscopy image data in some embodiments, may include measurement data (e.g., measurement results), may include measurement points (e.g., measurement arcs, measurement endpoints) or the like. The type of data provided will vary depending on the intended use of the machine learning model.

Server machine 180 includes a training engine 182, a validation engine 184, selection engine 185, and/or a testing engine 186. An engine (e.g., training engine 182, a validation engine 184, selection engine 185, and a testing engine 186) may refer to hardware (e.g., circuitry, dedicated logic, programmable logic, microcode, processing device, etc.), software (such as instructions run on a processing device, a general purpose computer system, or a dedicated machine), firmware, microcode, or a combination thereof. The training engine 182 may be capable of training a model (e.g., a machine learning model included in operations of measurement model 190) using one or more sets of features associated with the training set from data set generator 172. The training engine 182 may generate multiple trained models, where each trained model corresponds to a distinct set of features of the training set (e.g., sensor data from a distinct set of sensors). For example, a first trained model may have been trained using all features (e.g., X1-X5), a second trained model may have been trained using a first subset of the features (e.g., X1, X2, X4), and a third trained model may have been trained using a second subset of the features (e.g., X1, X3, X4, and X5) that may partially overlap the first subset of features.

Validation engine 184 may be capable of validating a trained model using a corresponding set of features of the validation set from data set generator 172. For example, a first trained machine learning model that was trained using a first set of features of the training set may be validated using the first set of features of the validation set. The validation engine 184 may determine an accuracy of each of the trained models based on the corresponding sets of features of the validation set. Validation engine 184 may discard trained models that have an accuracy that does not meet a threshold accuracy. In some embodiments, selection engine 185 may be capable of selecting one or more trained models that have an accuracy that meets a threshold accuracy. In some embodiments, selection engine 185 may be capable of selecting the trained model that has the highest accuracy of the trained models.

Testing engine 186 may be capable of testing a trained model using a corresponding set of features of a testing set from data set generator 172. For example, a first trained machine learning model that was trained using a first set of features of the training set may be tested using the first set of features of the testing set. Testing engine 186 may determine a trained model that has the highest accuracy of all of the trained models based on the testing sets.

In the case of one or more machine learning models, measurement model 190 may refer (at least in part) to the model artifact that is created by training engine 182 using a training set that includes data inputs and corresponding target outputs (correct answers for respective training inputs). Patterns in the data sets can be found that map the data input to the target output (the correct answer), and machine learning model is provided mappings that capture these patterns. The machine learning model may use one or more of Support Vector Machine (SVM), Radial Basis Function (RBF), clustering, supervised machine learning, semi-supervised machine learning, unsupervised machine learning, k-Nearest Neighbor algorithm (k-NN), linear regression, random forest, neural network (e.g., artificial neural network, recurrent neural network), etc.

In some embodiments, one or more machine learning models may be trained using historical data (e.g., historical metrology data, historical measurement data, etc.).

Measurement component 114 may provide current data of interest (e.g., metrology data of a substrate to be measured) to measurement model 190 and may run measurement model 190 on the input to obtain one or more outputs. Measurement component 114 may be capable of determining (e.g., extracting) generated measurement data 168 from the output of measurement model 190.

For purpose of illustration, rather than limitation, aspects of the disclosure describe the training of one or more machine learning models using historical data and inputting current data into the one or more trained machine learning models to determine generated measurement data 168. In other embodiments, a heuristic model, physics-based model, or rule-based model is used to determine generated measurement data 168 (e.g., without using a trained machine learning model). In some embodiments, such models may be trained or calibrated using historical data. In some embodiments, these models may be retrained utilizing historical data, labeled current data, etc.

In some embodiments, the functions of client device 120, measurement server 112, server machine 170, and server machine 180 may be provided by a fewer number of machines. For example, in some embodiments server machines 170 and 180 may be integrated into a single machine, while in some other embodiments, server machine 170, server machine 180, and measurement server 112 may be integrated into a single machine. In some embodiments, client device 120 and measurement server 112 may be integrated into a single machine. In some embodiments, functions of client device 120, measurement server 112, server machine 170, server machine 180, and data store 140 may be performed by a cloud-based service.

In general, functions described in one embodiment as being performed by client device 120, measurement server 112, server machine 170, and server machine 180 can also be performed on measurement server 112 or client device 120 in other embodiments, if appropriate. In addition, the functionality attributed to a particular component can be performed by different or multiple components operating together. For example, in some embodiments, measurement server 112 may determine the corrective action based on the generated measurement data 168. In another example, client device 120 may determine the generated measurement data 168 based on output from measurement model 190.

In addition, the functions of a particular component can be performed by different or multiple components operating together. One or more of the measurement server 112, server machine 170, or server machine 180 may be accessed as a service provided to other systems or devices through appropriate application programming interfaces (API).

In embodiments, a “user” may be represented as a single individual. However, other embodiments of the disclosure encompass a “user” being an entity controlled by a plurality of users and/or an automated source. For example, a set of individual users federated as a group of administrators may be considered a “user. ”

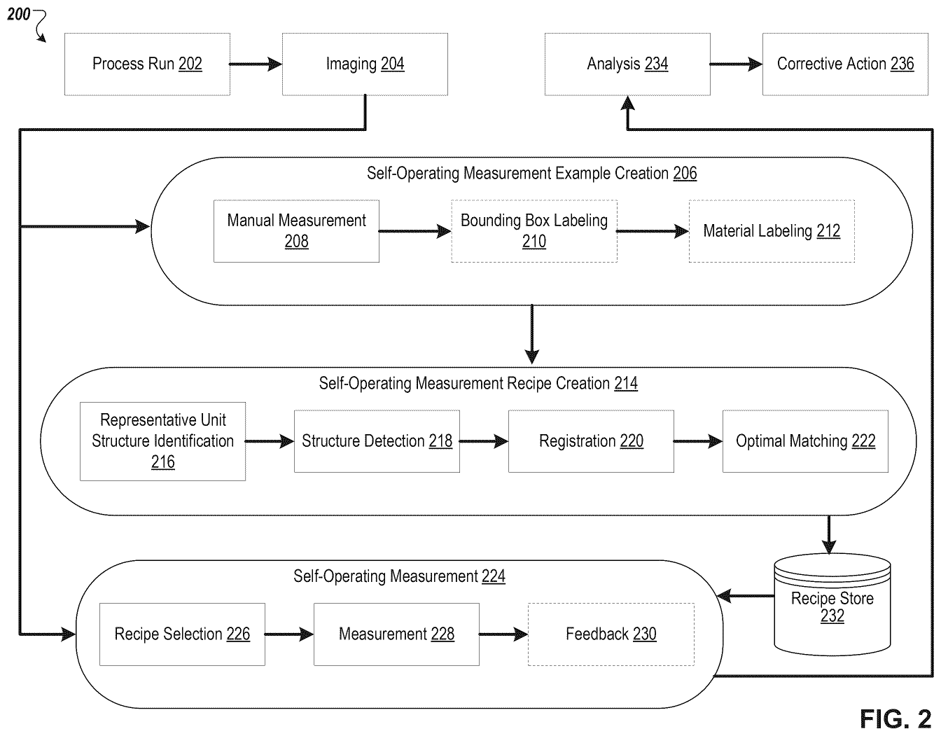

FIG. 2 is a block diagram depicting a flow 200 for generation and use of a self-operating measurement recipe, according to some embodiments.

Process run 202 is performed to generated a substrate. The process run 202 may include one or more process operations, one or more process chambers, one or more process tools, various types of processes (e.g., deposition processes, etch processes, anneal processes, etc.), etc. Process run 202 may be performed in accordance with a process recipe to generate a substrate (such as a semiconductor wafer) with target attributes, properties, performance, structures, design, etc.

A substrate generated by process run 202 is provided for imaging 204. Imaging 204 may be performed by a metrology instrument. Imaging 204 may be performed by an instrument of a standalone metrology facility, e.g., separate from the substrate processing equipment. Imaging 204 may generate an image of the substrate that includes information related to structures of the substrate, e.g., an array of structures repeatedly included on the substrate. Imaging 204 may include any imaging technique for substrate metrology, including SEM, TEM, etc. In some embodiments, imaging 204 may be or include synthetic imaging, e.g., predictive images based on sensor data, virtual metrology based on substrate data (e.g., optical reflectance data), or the like.

Substrate images from imaging 204 may be provided both so self-operating measurement example creation 206 and self-operating measurement 224. Self-operating measurement example creation 206 may include a user performing measurements based on a number of images, e.g., a number large enough to enable generation of a self-operating measurement recipe with a target degree of confidence. Self-operating measurement example creation 206 may include generation of example measurements for use in generating self-operating measurement recipes. Self-operating measurement example creation 206 may be provided 1 to 10 images, 3 to 5 images, or another number of images for a target recipe creation. Each image may include a number of structures which may be measured to generate an example measurement. Future images which are to be measured via a self-operating measurement recipe may be provided to self-operating measurement 224.

Referring to operations of self-operating measurement example creation 206, manual measurement 208 includes a self-operating measurement system receiving user measurements of images of imaging 204. Each image may include multiple structures of interest. Each image may include one or more measurements provided at manual measurement 208. Each image may include multiple types of measurements (e.g., various dimensions such as film thickness, structure width, structure spacing, sidewall angle, etc.). Each image may include multiple types of structures, which may each include multiple measurement types. In some embodiments, similar measurements may be linked together, e.g., by naming the measurements, by providing the measurements in a target order, or the like. The self-operating measurement system may use the linking data in generating the self-operating measurement recipe, e.g., by generating a measurement recipe based on one type or multiple types of measurement. Measurements may include selecting endpoints based on image structures, to generate a length measurement between endpoints. Measurements may include selecting an angle for measurement, e.g., between a base and sidewall of a substrate structure. Measurements may include selecting a number of points or an arc, e.g., to measure a length of a curved dimension of a structure, to measure a radius of curvature of a structure feature, or the like.

Flow optionally continues to bounding box labeling 210, which may include user definition of structure boundaries, structure grid, or the like. In some embodiments, a measurement recipe may be implemented including user labeling of bounds for use of the self-operating measurement recipe in generated representative unit structures during self-operating measurements. Self-operating measurement example creation 206 further optionally includes material labeling 212. Material labeling 212 may include user labeling of different materials of the substrate structures. Material labeling 212 may be augmented by machine learning or artificial intelligence models, e.g., computer vision models for separating different materials from the images. Material labeling 212 may include a user drawing or otherwise indicating different materials, interfaces between materials, or the like.

Flow continues to self-operating measurement recipe creation 214. A method for identifying representative unit structures is generated at representative unit structure identification 216. Representative unit structure identification 216 may include or be based on bounding box labeling 210, e.g., the contents of bounding boxes labeled by a user may be utilized in determining structures of target images. For example, computer vision techniques may be used to find regions of an image with structures, shapes, edges, or the like corresponding to those included in bounding boxes provided by a user. In some embodiments, representative unit structure identification 216 may be based on manual measurement 208. For example, a frequency of measurement may be used to determine a frequency of occurrence of structures of interest. Measurement bounds may be used to determine or approximate bounds of structures. Computer vision techniques, together with manual measurements, may be utilized in determining structures of interest, generating unit structure information, and the like. Representative unit structure identification may be determined based on various materials identified in target images. For example, a pattern of different materials repeated in test images of example creation may be utilized in recognizing unit structures in representative unit structure identification 216. In some embodiments, a matching algorithm may be performed based on centroids of various materials identified. For example, a Hungarian matching algorithm may be used to reduce or minimize differences in centroid locations of various identified materials compared to example images, for assigning identities of compounds identified in target images.

Flow continues to structure detection 218, which may include or be based on representative unit structure identification 216. For example, each representative unit structure may include a single structure of interest, which may be identified based on bounding boxes assigned in representative unit structure identification 216. Structure detection 218 may further include computer vision techniques, machine learning techniques, etc. Structure detection 218 may instead or additionally be based on identification of various materials included in structures of interest.

Registration 220 may include various methods for correcting for or accounting for distortion or differences between example images and target images, for example distortions between substrate structures, differences between imaging techniques, procedures, or instruments, or the like. Registration 220 may include generation of a distortion field between example image structures and target image structures identified in structure detection 218. Registration 220 may be used to transfer measurements of manual measurement 208 (e.g., measurement endpoints) from example structures to target structures. Registration 220 may be or include rigid registration, which includes transformations that preserve distances and angles. For example, rigid registration may include structures that are translated, rotated, scaled, or the like compared to example structures. Registration 220 may include non-rigid or deformation registration. Non-rigid registration may generate a deformation field that allows shapes of structures to be distorted. The deformation field may be used to transfer measurement endpoints, measurement arcs, or the like from example to target structures.

Optimal matching 222 may be used to improve on operations of registration 220, e.g., to improve performance of self-operating measurement recipe. Optimal matching may include performing a matching algorithm, such as dynamic time warping. In some embodiments, measurement endpoints may be chosen from a range of potential measurement endpoints, e.g., along the direction of a measurement arc. In some embodiments, pixel values may be averaged along a first dimension, and the average values may be used to construct a trace for dynamic time warping comparison with one or more example measurements. In some embodiments, optimal matching may be performed independently for a single target structure with a number of example structure measurements.

Upon creation of a self-operating measurement recipe, the recipe is provided to recipe store 232 for recipe storage. Future images to be measured in accordance with the recipe (e.g., images associated with similar measurements) may be measured by the self-operating measurement recipe, upon selection of the recipe by a user, e.g., via a graphical user interface, in response to substrate of a target type or design being imaged, or the like. Images are then provided for self-operating measurement 224, where recipe selection 226 is performed to select the target measurement recipe from a number of recipes included in recipe store 232.

Self-operating measurement 224 continues to measurement 228. Measurement 228 may execute one or more of the operations generated, calibrated, refined, or the like during self-operating measurement recipe creation 214. Upon performing measurement 228, optional feedback 230 may be provided, e.g., by a user based on conclusions of self-operating measurement 224, based on differences between output of self-operating measurement 224 and measurements of other methods, based on uncertainty of output of measurement 228, or the like. Data indicative of measurements, measurement certainty, feedback, etc. may be provided for analysis 234, which may for example include recommended corrective actions 236, which may be performed based on analysis 234. Corrective actions may include updating a process recipe, updating a measurement technique, updating a self-operating measurement recipe, scheduling or recommending maintenance, providing an alert to a user, flagging a substrate associated with a target image for further screening, or the like.

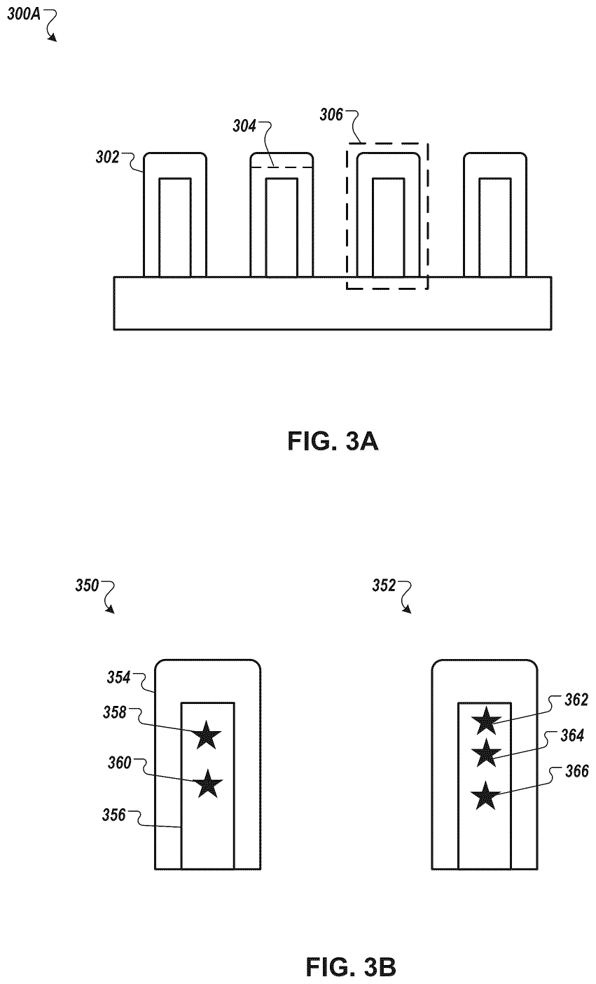

FIG. 3A is a block diagram of substrate image 300A including example measurements, according to some embodiments. Substrate image 300A (and the associated substrate) includes an array of structures 302. Substrate image 300A may have one or more measurements associated with one or more structures 302 applied by a user. For example, measurement 304 may be provided by a user to determine a width of structures of the substrate. A user may provide a similar measurement on multiple (e.g., every) structure of the image to provide additional context for generation and operation of self-operating measurement recipes. Multiple types of measurement may be provided, e.g., multiple measurement associated with different properties of substrate structures. In some embodiments, measurements may be used to determine boundaries of structures of substrates.

In some embodiments, bounding boxes such as bounding box 306 may be provided by a user. Bounding box 306 may be used to determine representative unit structures of target substrate images. Regions including similar patterns as regions including in bounding box 306 may be determined to be structures of interest in a target substrate image. Upon determination of a representative unit structure and/or substrate structure of a target image, registration may be performed for transferring measurements (e.g., measurement endpoints, measurement arc, etc.) from example structure images to target structure images for performance of self-operating substrate measurement.

FIG. 3B depicts block diagrams of material labeling of example structure 350 and target structure 352, according to some embodiments. Example structure 350 may have various materials of the structure labeled by a user. For example, first material 354 may be labeled (e.g., by drawing boundaries around the material, by drawing an approximate shape of the material structure and correcting the approximation with computer vision or other edge-finding techniques, or the like) by a user on an example image including example structure 350. Further materials (e.g., second material 356, additional materials, etc.) may be labeled by a user as well.

In some embodiments, a centroid of each structure, a centroid of one or more structure materials, or the like may be identified. For example, a first centroid 358 associated with first material 354 and a second centroid 360 associated with second material 356 may be identified in an example image by a user. In a target image, e.g., using computer vision techniques, various potential materials may be identified and centroids of each identified, for example candidate centroids 362-366.

In some embodiments, a matching procedure may be performed for determining which centroids of a target structure are most likely to correspond with centroids of an example structure. For example, an algorithm may determine which combination of material and/or structure centroid positions identified in target structure 352 minimizes cumulative distances (e.g., within a representative unit structure) between example material centroids and target material centroids. Determining correspondences between example structure materials and target structure materials may improve processes of unit structure identification, structure registration, etc.

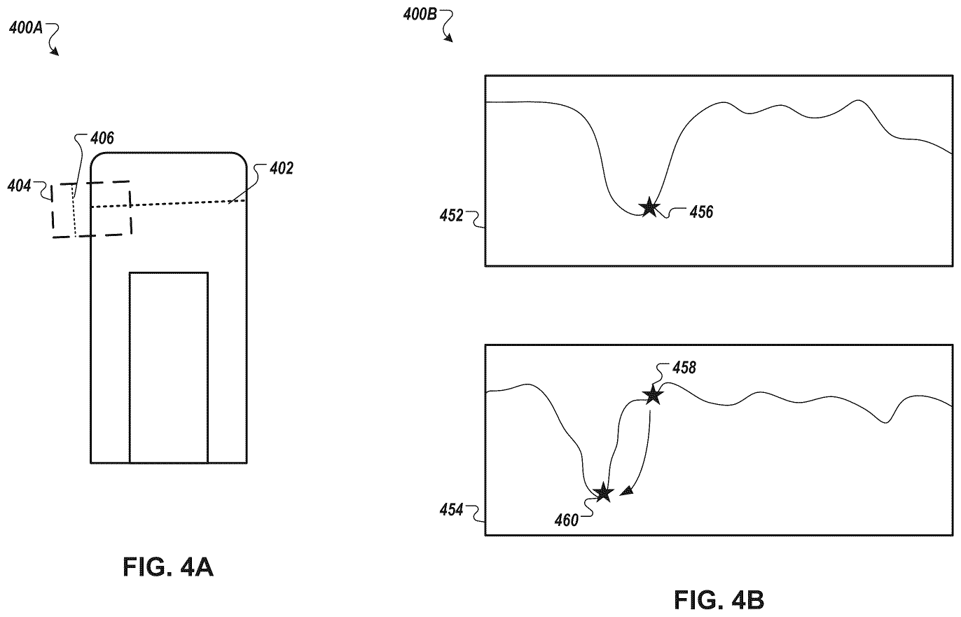

FIG. 4A depicts a substrate structure image 400A with measurement arc 402 to be adjusted in accordance with an optimal matching technique, according to some embodiments. Measurement arc 402 (e.g., as depicted in FIG. 4A, a straight measurement between two endpoints) may have been provided to the structure image based on a deformation field representing distortion of the substrate structure image 400A with respect to one or more example images. For example, example images may have included horizontal measurements, but distortion of the target image with respect to example images may cause points of measurements (e.g., measurement endpoints) to be placed differently, such that the measurement accounts for deformation between the images.

For adjustment of one or more points of a measurement based on optimal matching (e.g., dynamic time warping), a window may be defined around the one or more endpoints, such as matching window 404. Points within matching window 404 may be utilized to improve placement of measurement points, e.g., endpoints of measurement arcs. Optimal matching operations may be used to select a location along the measurement arc (e.g., extended beyond the arc created based on registration) that best matches placement of measurement points of example measurements, e.g., locations of measurement endpoints with respect to interfaces between material boundaries, etc.

In some embodiments, data points within matching window 404 may be utilized in determining optimal measurement points. For example, lines or arcs of data points (e.g., pixel brightness values) perpendicular or otherwise independent of the measurement arc may be used statistically to determine a data point for optimal matching, and a trace of such statistically determined data points utilized for generating a trace for optimal matching algorithms. Pixel brightness values in averaging zone 406, for example, may be averaged to determine a data point of a data trace for determining where to place a measurement endpoint.

FIG. 4B includes example traces 400B that may be used for optimal matching, according to some embodiments. Traces 400B include example trace 452 and matching window trace 454 associated with a measurement endpoint to be placed as part of self-operating measurement. The vertical axis of the traces 400B represent a target property of the image (e.g., pixel brightness) and the horizontal axis of the traces 400B represent data points along the provisional measurement arc, to be corrected by adjusting locations of one or more measurement points based on optimal matching.

Example trace 452 includes a measurement point placement 456. Measurement point placement 456 may have been provided during user measurement of an example substrate image. Measurement point placement 456 may have been provided based on one or more structure features, e.g., interfaces between portions of structures in the example image (e.g., identified based on pixel brightness, image edges, or the like). Providing a target measurement point on a target image placed similarly with respect to properties of the image may improve performance of the self-operating measurement.

Matching window trace 454 is of a somewhat different shape than example trace 452, and the peak is shifted compared to example trace 452. After registration, measurement points may be placed according to a distortion field, which may be improved by associating image properties of the location of the endpoint in the target image with image properties of the location chosen in the example image. For example, provisional measurement point placement 458, based on image distortion determined during registration, may be adjusted to final measurement point placement 460 based on properties of the image proximate the provisional endpoint (e.g., in the optimal matching window). Final measurement point placement 460 may be more similar in terms of location with respect to the structure image to measurement point placement 465, and may improve the self-operating measurement accuracy.

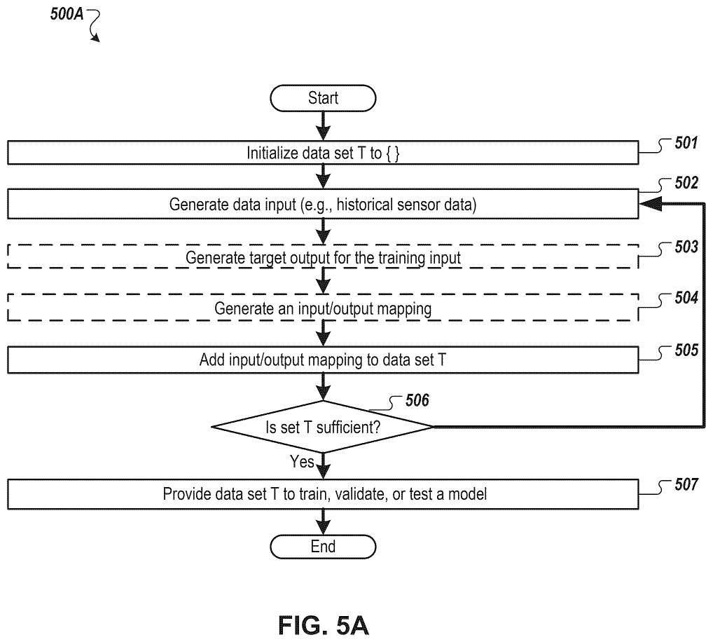

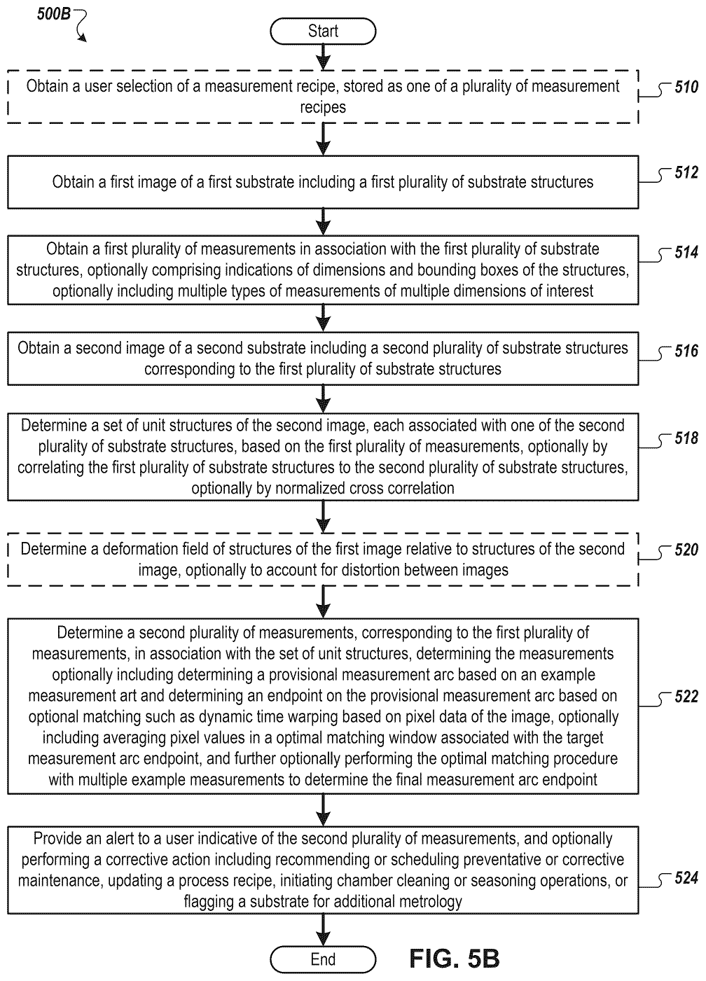

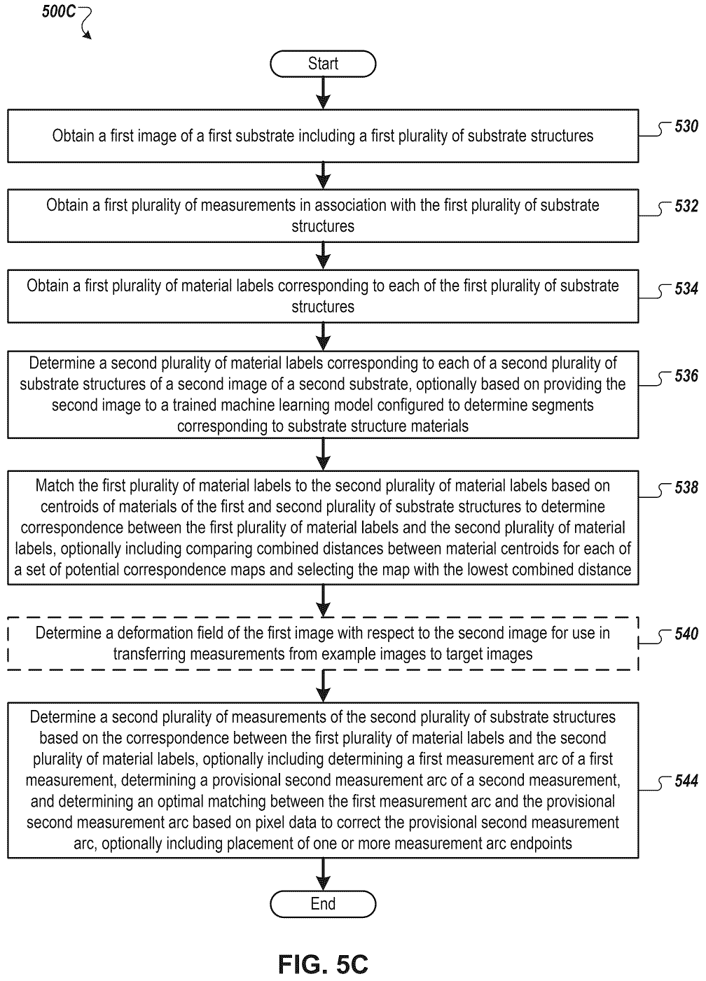

FIGS. 5A-C are flow diagrams of methods 500A-C associated with generating and enacting self-operating measurement techniques, according to certain embodiments. Methods 500A-C may be performed by processing logic that may include hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiment, methods 500A-C may be performed, in part, by predictive system 110. Method 400A may be performed, in part, by self-operating measurement management system 110 (e.g., server machine 170 and data set generator 172 of FIG. 1). Self-operating measurement management system 110 may use method 400A to generate a data set to at least one of train, validate, or test a machine learning model, in accordance with embodiments of the disclosure. Methods 500B-C may be performed by measurement server 112 (e.g., measurement component 114) and/or server machine 180 (e.g., training, validating, and testing operations may be performed by server machine 180). In some embodiments, a non-transitory machine-readable storage medium stores instructions that when executed by a processing device (e.g., of self-operating measurement management system 110, of server machine 180, of measurement server 112, etc.) cause the processing device to perform one or more of methods 500A-C.

For simplicity of explanation, methods 500A-C are depicted and described as a series of operations. However, operations in accordance with this disclosure can occur in various orders and/or concurrently and with other operations not presented and described herein. Furthermore, not all illustrated operations may be performed to implement methods 500A-C in accordance with the disclosed subject matter. In addition, those skilled in the art will understand and appreciate that methods 500A-C could alternatively be represented as a series of interrelated states via a state diagram or events.

FIG. 5A is a flow diagram of a method 500A for generating a data set for a machine learning model, according to some embodiments. Referring to FIG. 5A, in some embodiments, at block 501 the processing logic implementing method 500A initializes a training set T to an empty set.

At block 502, processing logic generates first data input (e.g., first training input, first validating input) that may include one or more of example measurement data, measurement images, example images, etc. In some embodiments, the first data input may include a first set of features for types of data and a second data input may include a second set of features for types of data. Input data may include historical data in some embodiments.

In some embodiments, at block 503, processing logic optionally generates a first target output for one or more of the data inputs (e.g., first data input). In some embodiments, the target output includes one or more metrology measurements and the input is a microscopy image. In some embodiments, the first target output is predictive data. In some embodiments, input data may be in the form of metrology data and target output may be a list of components likely to be faulty, as in the case of a machine learning model configured to identify failing manufacturing systems, a recommended corrective action, or the like. In some embodiments, no target output is generated (e.g., an unsupervised machine learning model capable of grouping or finding correlations in input data, rather than requiring target output to be provided).

At block 504, processing logic optionally generates mapping data that is indicative of an input/output mapping. The input/output mapping (or mapping data) may refer to the data input (e.g., one or more of the data inputs described herein), the target output for the data input, and an association between the data input(s) and the target output. In some embodiments, such as in association with machine learning models where no target output is provided, block 504 may not be executed.

At block 505, processing logic adds the mapping data generated at block 504 to data set T, in some embodiments.

At block 506, processing logic branches based on whether data set T is sufficient for at least one of training, validating, and/or testing a machine learning model, such as measurement model 190 of FIG. 1. If so, execution proceeds to block 507, otherwise, execution continues back at block 502. It should be noted that in some embodiments, the sufficiency of data set T may be determined based simply on the number of inputs, mapped in some embodiments to outputs, in the data set, while in some other embodiments, the sufficiency of data set T may be determined based on one or more other criteria (e.g., a measure of diversity of the data examples, accuracy, etc.) in addition to, or instead of, the number of inputs.

At block 507, processing logic provides data set T (e.g., to server machine 180) to train, validate, and/or test a machine learning model, e.g., included in measurement model 190. In some embodiments, data set T is a training set and is provided to training engine 182 of server machine 180 to perform the training. In some embodiments, data set T is a validation set and is provided to validation engine 184 of server machine 180 to perform the validating. In some embodiments, data set T is a testing set and is provided to testing engine 186 of server machine 180 to perform the testing. In the case of a neural network, for example, input values of a given input/output mapping (e.g., numerical values associated with data inputs) are input to the neural network, and output values (e.g., numerical values associated with target outputs) of the input/output mapping are stored in the output nodes of the neural network. The connection weights in the neural network are then adjusted in accordance with a learning algorithm (e.g., back propagation, etc.), and the procedure is repeated for the other input/output mappings in data set T. After block 507, a model (e.g., measurement model 190) can be at least one of trained using training engine 182 of server machine 180, validated using validating engine 184 of server machine 180, or tested using testing engine 186 of server machine 180. The trained model may be implemented by measurement component 114 (of measurement server 112) to generate generated measurement data 168 for performing signal processing, or for performing a corrective action associated with manufacturing equipment 124.

FIG. 5B is a flow diagram of a method 500B for generating and initiating a self-operating measurement recipe, according to some embodiments. At block 510, process logic optionally obtains a user selection of a measurement recipe. The measurement recipe may be stored as one of a plurality of measurement recipes for user selection. Further operations may be based on the selection of the measurement recipe.

At block 512, process logic obtains a first image of a first substrate including a first plurality of substrate structures. The first image may be a metrology image, e.g., an SEM image, a TEM image, or the like. The first image may include one type of structure, multiple types of structures, or the like.

At block 514, process logic obtains a first plurality of measurements in association with the first plurality of substrate structures. Multiple of a single type of measurement may be performed, e.g., a first dimension of interest may be measured in association with each of the plurality of substrate structures. Multiple types of measurement may be performed, e.g., multiple dimensions of interest may be measured in association with each of the plurality of substrate structures. Optionally a user may provide bounding boxes associated with the structures, which may be used by the system to find representative unit structures of a target image based on the example bounding boxes.

At block 516, process logic obtains a second image of a second substrate including a second plurality of substrate structures corresponding to the first plurality of substrate structures. The second image may be similar to the first image, e.g., may include an array of structures corresponding to structures pictured in the first image.

At block 518, process logic determines a set of unit structures of the second image. Each of the set of unit structures may be associated with, and/or representative of, one of the second plurality of substrate structures. Determining the set of unit structures may be based on the first plurality of measurements. Determining the set of unit structures may optionally be performed by correlating the first plurality of substrate structures to the second plurality of substrate structures, e.g., by a technique such as normalized cross correlation.

At block 520, process logic optionally determines a deformation field indicative of distortion of structures of the first image relative to structures of the second image. This process may include rigid registration. This process may include non-rigid registration.

At block 522, process logic determines a second plurality of measurements.

The second plurality of measurements correspond to the first plurality of measurements, e.g., measure the same types of measurements, the same dimensions, the same regions, or the like as the structures of the first plurality of measurements. Each of the second plurality of measurements may be associated with one of the unit structures identified in the second image.

Determining the measurement may include determining a provisional measurement arc based on one or more example measurement arcs. For example, one or more measurement points may be transferred from an example measurement of an example structure to a target structure image. The measurement arc may be a straight line (e.g., between measurement endpoints), or another shape defined by other measurement points, e.g., two endpoints and a third non-colinear point defining a circular arc, for example.

Determining the measurement may further include determining a measurement endpoint along a provisional measurement arc (e.g., including extending beyond the provisional measurement arc along the same arc path). For example, a measurement endpoint of a horizontal measurement line may be moved left or right, subject to further calculations to improve results of self-operating measurements. Determining the endpoint may be based on optimal matching methods, such as dynamic time warping.

Optimal matching operations may occur within a matching window, e.g., a window of potential endpoint locations, a window including potential endpoint locations and other points for use in determining optimal matching, or the like. In some embodiments, image properties (e.g., pixel brightness) along a first dimension (e.g., associated with edges of structures of the images, perpendicular to the measurement arc, or the like) may be averaged or otherwise included together to improve accuracy of optimal matching operations to choose a measurement endpoint along the provisional measurement arc. In some embodiments, an average location for the measurement endpoint based on performing optimal matching with multiple example measurements may be used to improve accuracy of placement of the measurement endpoint.

At block 524, process logic provides an alert to a user indicative of the second plurality of measurements. Further corrective actions may be optionally performed, such as recommending or scheduling preventative or corrective maintenance, updating a process recipe, initiating chamber cleaning or seasoning operations, flagging a substrate for additional metrology, updating metrology procedures, flagging a metrology instrument for investigation, or the like.

FIG. 5C is a flow diagram of a method 500C for generating and utilizing a self-operating measurement recipe including identification of materials of substrate structure images, according to some embodiments. At block 530, process logic obtains a first image of a first substrate including a first plurality of substrate structures. Operations of block 530 may share one or more features with operations of block 512.

At block 532, process logic obtains a first plurality of measurements in association with the first plurality of substrate structures. Operations of block 532 may share one or more features with operations of block 514.

At block 534, process logic obtains a first plurality of material labels corresponding to each of the first plurality of substrate structures. The material labels may be provided by a user, e.g., using a graphical user interface of a client device associated with the self-operating measurement system (e.g., connected via a network to other devices of the system). The material labels may include material names or material designations (e.g., first material, second material, etc.). The labels may be provided based on fields separated by computer vision techniques, by a user drawing or otherwise blocking out materials or material interfaces, or the like.

At block 536, process logic determines a second plurality of material labels corresponding to each of a second plurality of substrate structures of a second image of a second substrate. Optionally determining the second plurality of material labels may be based on providing the second image to a trained machine learning model configured to determine segments of the image and/or structures corresponding to different materials, material interfaces, or the like.

At block 538, process logic matches the first plurality of material labels to the second plurality of material labels. For example, each structure of the first image may be compared to each structure of the second image, and correspondences between materials of the first and second determined. In some embodiments, determining material correspondences may be based on centroids associated with various materials of the substrate structures. In some embodiments, based on representative unit structures, structure correlation, structure registration, etc., a structure including example measurements and a structure to be measured may be aligned. Candidate material and/or structure centroids may be compared, with possible combinations incurring cumulative distances between locations represented in the example image and prospective locations of material centroids in the target image. In some embodiments, the combination of candidate material centroids with the lowest cumulative distance compared to locations of the example measurements may be selected as the material map of the target image.

At block 540, process logic optionally determines a deformation field of the first image with respect to the second image for use in transferring measurements from example images to target images. In some embodiments, this operation may occur before operations described in connection with block 538.

At block 544, process logic determines a second plurality of measurements of the second plurality of substrate structures based on the correspondence between the first plurality of material labels and the second plurality of material labels. In some embodiments, operations of block 544 may share one or more features with operations of block 522. For example, at block 544, one or more points may be transferred from example images to target images, optimal matching operations may be performed to correct measurement endpoints along measurement arcs, and the like.

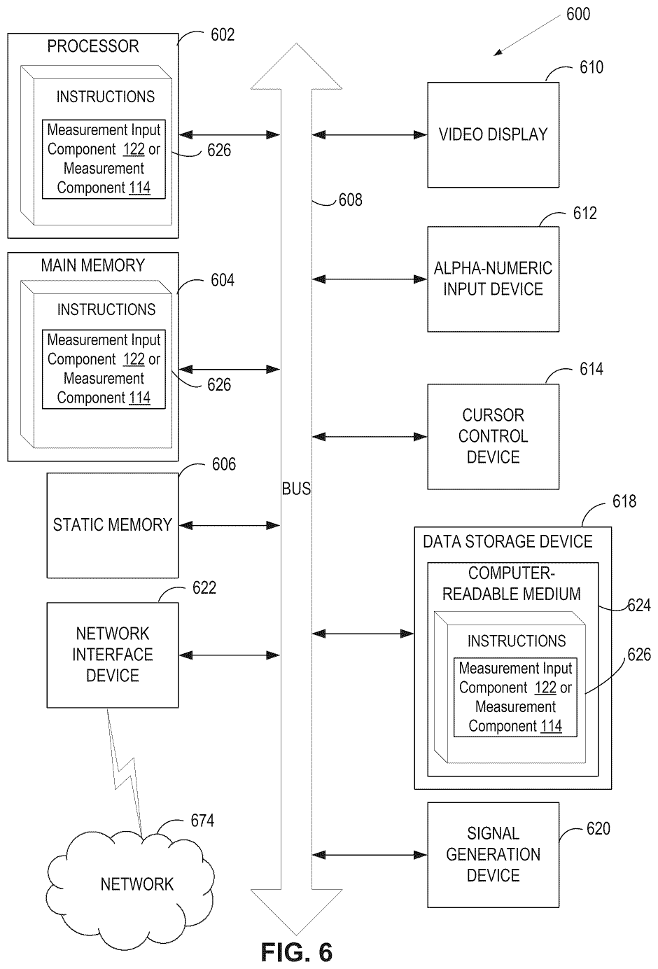

FIG. 6 is a block diagram illustrating a computer system 600, according to some embodiments. In some embodiments, computer system 600 may be connected (e.g., via a network, such as a Local Area Network (LAN), an intranet, an extranet, or the Internet) to other computer systems. Computer system 600 may operate in the capacity of a server or a client computer in a client-server environment, or as a peer computer in a peer-to-peer or distributed network environment. Computer system 600 may be provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 600 may include a processing device 602, a volatile memory 604 (e.g., Random Access Memory (RAM)), a non-volatile memory 606 (e.g., Read-Only Memory (ROM) or Electrically-Erasable Programmable ROM (EEPROM)), and a data storage device 618, which may communicate with each other via a bus 608.

Processing device 602 may be provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

Computer system 600 may further include a network interface device 622 (e.g., coupled to network 674). Computer system 600 also may include a video display unit 610 (e.g., an LCD), an alphanumeric input device 612 (e.g., a keyboard), a cursor control device 614 (e.g., a mouse), and a signal generation device 620.

In some embodiments, data storage device 618 may include a non-transitory computer-readable storage medium 624 (e.g., non-transitory machine-readable medium, non-transitory machine-readable storage medium, or the like) on which may store instructions 626 encoding any one or more of the methods or functions described herein, including instructions encoding components of FIG. 1 (e.g., measurement component 114, measurement input component 122, measurement model 190, etc.) and for implementing methods described herein.

Instructions 626 may also reside, completely or partially, within volatile memory 604 and/or within processing device 602 during execution thereof by computer system 600, hence, volatile memory 604 and processing device 602 may also constitute machine-readable storage media.

While computer-readable storage medium 624 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “performing,” “providing,” “obtaining,” “causing,” “accessing,” “determining,” “adding,” “using,” “training,” “reducing,” “generating,” “correcting,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may include a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and embodiments, it will be recognized that the present disclosure is not limited to the examples and embodiments described. The scope of the disclosure should be determined with reference to the following claims, along with the full scope of equivalents to which the claims are entitled.

What is claimed is:

1. A method comprising:
obtaining, by a processing device, a first image of a first substrate comprising a first plurality of substrate structures;
obtaining a first plurality of measurements in association with the first plurality of substrate structures;
obtaining a second image of a second substrate comprising a second plurality of substrate structures corresponding to the first plurality of substrate structures;
determining a set of unit structures of the second image, each associated with one of the second plurality of substrate structures, based on the first plurality of measurements;
determining a second plurality of measurements, corresponding to the first plurality of measurements, in association with the set of unit structures; and
providing an alert to a user indicative of the second plurality of measurements.

2. The method of claim 1, wherein the first plurality of measurements comprises indications of a dimension of the first plurality of substrate structures, and bounding boxes corresponding to each of the first plurality of substrate structures, wherein determining the set of unit structures of the second image is based on the bounding boxes corresponding to each of the first plurality of substrate structures.

3. The method of claim 1, wherein determining the set of unit structures comprises performing a calculation correlating the first plurality of substrate structures to the second plurality of substrate structures.

4. The method of claim 1, further comprising determining a deformation field of the first image with respect to the second image, wherein determining the second plurality of measurements comprises determining endpoints of the second plurality of measurements based on endpoints of the first plurality of measurements, in further view of the deformation field.

5. The method of claim 1, wherein determining the second plurality of measurements comprises:
determining a first measurement arc of a first measurement of the first plurality of measurements;
determining a provisional second measurement arc of a second measurement of the second plurality of measurements;
determining an optimal matching between the first measurement arc and the provisional second measurement arc based on image pixel data; and
correcting the provisional second measurement arc to obtain the second measurement of the second plurality of measurements.

6. The method of claim 5, wherein determining the optimal matching comprises:
determining a two-dimensional matching window for use in association with the first measurement arc and the provisional second measurement arc;
averaging pixel data values along a first coordinate, different than a coordinate defined by the first measurement arc and the provisional second measurement arc; and
performing dynamic time warping to determine optimal matching between a first set of averaged pixel values corresponding to the first measurement arc and a second set of averaged pixel values corresponding to the provisional second measurement arc.

7. The method of claim 5, further comprising:
determining a third measurement arc of a third measurement of the first plurality of measurements; and
determining an optimal matching between the third measurement arc and the provisional second measurement arc, wherein correcting the provisional second measurement arc to obtain the second measurement is based on the optimal matching between the third measurement arc and the provisional second measurement arc, and on the optimal matching between the first measurement arc and the provisional second measurement arc.

8. The method of claim 1, further comprising performing a corrective action based on the second plurality of measurements, wherein the corrective action comprises one or more of:
recommending preventative maintenance;
scheduling corrective maintenance;
updating a process recipe;
initiating a chamber cleaning or seasoning operation; or
flagging the second substrate for additional metrology.

9. The method of claim 1, further comprising:
obtaining a third plurality of measurements in association with the first plurality of substrate structures, wherein the first plurality of measurements correspond to a first dimension of interest of the first plurality of substrate structures, and the third plurality of measurements correspond to a second dimension of interest of the first plurality of substrate structures, different than the first plurality of substrate structures; and
determining a fourth plurality of measurements of the second plurality of substrate structures, corresponding to the third plurality of measurements.

10. The method of claim 1, further comprising:
storing indications of the first plurality of measurements as a measurement recipe; and
obtaining a user selection of the measurement recipe, wherein determining the set of unit structures is performed in view of the user selection of the measurement recipe.

11. A method comprising:
obtaining, by a processing device, a first image of a first substrate comprising a first plurality of substrate structures;
obtaining a first plurality of measurements in association with the first plurality of substrate structures;
obtaining a first plurality of material labels corresponding to each of the first plurality of substrate structures;
determining a second plurality of material labels corresponding to each of a second plurality of substrate structures of a second image of a second substrate;
matching the first plurality of material labels to the second plurality of material labels based on centroids of materials of the first and second plurality of substrate structures to determine correspondence between the first plurality of material labels and the second plurality of material labels; and
determining a second plurality of measurements of the second plurality of substrate structures based on the correspondence between the first plurality of material labels and the second plurality of material labels, and the first plurality of measurements.

12. The method of claim 11, wherein matching the first plurality of material labels to the second plurality of material labels comprises comparing combined distances between material centroids for each of a set of potential correspondence maps, and selecting the correspondence map with the lowest combined distance.

13. The method of claim 11, wherein determining the second plurality of material labels comprises providing the second image to a trained machine learning model configured to process the image to determine segments corresponding to substrate structure materials.

14. The method of claim 11, further comprising determining a deformation field of the first image with respect to the second image, wherein determining the second plurality of measurements comprises determining endpoints of the second plurality of measurements based on endpoints of the first plurality of measurements, in further view of the deformation field.

15. The method of claim 11, wherein determining the second plurality of measurements comprises:
determining a first measurement arc of a first measurement of the first plurality of measurements;
determining a provisional second measurement arc of a second measurement of the second plurality of measurements;
determining an optimal matching between the first measurement arc and the provisional second measurement arc based on image pixel data; and
correcting the provisional second measurement arc to obtain the second measurement of the second plurality of measurements.

16. A non-transitory machine-readable storage medium storing instructions which, when executed, cause a processing device to perform operations comprising:
obtaining a first image of a first substrate comprising a first plurality of substrate structures;
obtaining a first plurality of measurements in association with the first plurality of substrate structures;
obtaining a second image of a second substrate comprising a second plurality of substrate structures corresponding to the first plurality of substrate structures;
determining a set of unit structures of the second image, each associated with one of the second plurality of substrate structures, based on the first plurality of measurements;
determining a second plurality of measurements, corresponding to the first plurality of measurements, in association with the set of unit structures; and
providing an alert to a user indicative of the second plurality of measurements.

17. The non-transitory machine-readable storage medium of claim 16, further comprising determining a deformation field of the first image with respect to the second image, wherein determining the second plurality of measurements comprises determining endpoints of the second plurality of measurements based on endpoints of the first plurality of measurements, in further view of the deformation field.

18. The non-transitory machine-readable storage medium of claim 17, wherein determining the second plurality of measurements comprises:
determining a first measurement arc of a first measurement of the first plurality of measurements;
determining a provisional second measurement arc of a second measurement of the second plurality of measurements, in view of the deformation field;
determining an optimal matching between the first measurement arc and the provisional second measurement arc based on image pixel data; and
correcting the provisional second measurement arc to obtain the second measurement of the second plurality of measurements.

19. The non-transitory machine-readable storage medium of claim 18, wherein determining the optimal matching comprises:
determining a two-dimensional matching window for use in association with the first measurement arc and the provisional second measurement arc;
averaging pixel data values along a first coordinate, different than a coordinate defined by the first measurement arc and the provisional second measurement arc; and
performing dynamic time warping to determine optimal matching between a first set of averaged pixel values corresponding to the first measurement arc and a second set of averaged pixel values corresponding to the provisional second measurement arc.

20. The non-transitory machine-readable storage medium of claim 18, wherein the operations further comprise:
determining a third measurement arc of a third measurement of the first plurality of measurements; and
determining an optimal matching between the third measurement arc and the provisional second measurement arc, wherein correcting the provisional second measurement arc to obtain the second measurement is based on the optimal matching between the third measurement arc and the provisional second measurement arc, and on the optimal matching between the first measurement arc and the provisional second measurement arc.
